(19) United States
(12) Patent Application Publication
(10) Pub. No.: US 2026/0203194 A1
(43) Pub. Date: Jul. 16, 2026

(54) Hardware-Assisted Instruction-Level Debugging

(71) Applicant: Google LLC, Mountain View, CA (US)

(72) Inventors: Mohan Upase, Bengaluru (IN); Janardan Prasad, Bangalore (IN); Olivier Maurice Marcel Cozette, San Francisco, CA (US); Nikhil Nandkishor Devshatwar, Bangalore (IN)

(73) Assignee: Google LLC, Mountain View, CA (US)

(21) Appl. No.: 19/533,718

(22) Filed: Feb. 9, 2026

Related U.S. Application Data
(60) Provisional application No. 63/977,397, filed on Feb. 6, 2026.

(51) Int. Cl. G06F 11/362; G06F 11/30

(52) U.S. Cl. CPC G06F 11/3648; G06F 11/3037; G06F 11/366

(57) ABSTRACT

The present document describes techniques for use in troubleshooting and debugging complex circuits, devices, and systems. These techniques may be implemented to provide hardware-assisted instruction-level debugging. By way of an example, techniques are provided that may be implemented in an apparatus having a plurality of state sequencers. The techniques may include receiving signals from a plurality of state sequencers, and storing an instruction history indicated, at least in part, by one or more of the signals received from a selected one of the state sequencers. The stored instruction history may indicate at least a state of the selected state sequencer during a specific cycle of instruction execution.

### CROSS-REFERENCE TO RELATED APPLICATION

This application claims the benefit of U.S. Provisional Patent Application Ser. No. 63/977,397 filed on Feb. 6, 2026, the disclosure of which is incorporated by reference herein in its entirety.

### BACKGROUND

In modern System-on-Chip (SoC) and other complex systems, state controllers, such as power controllers are valuable components that manage transitions between various states to reduce or otherwise control energy/power consumption or for other reasons. These state controllers often utilize state sequencers—specialized hardware blocks responsible for controlling clocks and power in certain domain of circuits, e.g., based on device activity. While historical power management was largely controlled by software, the industry trend has shifted toward moving these functionalities into complex, “black box” hardware state sequencers.

This shift presents significant challenges for debugging and performance analysis. When a performance issue or a “hang” occurs during a particular state transition, engineers often lack the granular data needed to readily identify the root cause. Existing debug tools typically provide only coarse-grained event logging or high-level flow timers, which may prove insufficient for determining which specific instruction within a sequencer is causing a delay or failure. Currently, for example, engineers may rely on “scan dumps,” which may only provide the current state of the system without historical context, or may resort to iterative software patching to “guess” the location of the failure.

Accordingly, for these reasons and others, there is a continuing need for improved troubleshooting and debugging techniques and tools.

### SUMMARY

This summary is not intended to identify essential features of the claimed subject matter, nor is it intended for use in determining the scope of the claimed subject matter.

In accordance with certain aspects of the present description, techniques are provided that may be implemented in an apparatus having a plurality of state sequencers. The techniques may, for example, include receiving signals from a plurality of state sequencers, and storing an instruction history indicated, at least in part, by one or more of the signals received from a selected one of the state sequencers. Here, for example, the stored instruction history may indicate at least a state of the selected state sequencer during a specific cycle of instruction execution.

In accordance with still other aspects of the present description, techniques are provided that may be implemented in an apparatus having a selection circuit configured to receive signals from a plurality of state sequencers and route signals from a selected state sequencer to a debug source interface, and a debug circuit coupled to the debug source interface. The debug circuit may include a memory configured to store an instruction history of the selected state sequencer. The debug circuit may be configured to record in the memory, for each instruction in the instruction history, at least a state of the selected state sequencer during a specific cycle of instruction execution.

### BRIEF DESCRIPTION OF DRAWINGS

The details of one or more aspects of hardware-assisted instruction-level debugging are described in this document with reference to the following drawings. The same numbers are used throughout the drawings to reference like features and components:

FIG. 1 is a block diagram of an example environment that includes an electronic device having hardware-assisted instruction-level debugging, in accordance with certain example implementations of the present description;

FIG. 2 is a block diagram illustrating further aspects and form factors of the electronic device from FIG. 1, in accordance with certain example implementations of the present description;

FIG. 3 is a timing diagram illustrating certain relationships between an electronic device, for example, as in FIG. 1, having hardware-assisted instruction-level debugging components and an external device, in accordance with certain example implementations of the present description;

FIG. 4 is a block diagram illustrating some example types of debugging information that may be part of a stored instruction history of an electronic device, for example, as in FIG. 1, having certain hardware-assisted instruction-level debugging capabilities, in accordance with certain example implementations of the present description;

FIG. 5 is a block diagram illustrating aspects of an electronic device, for example, as in FIG. 1, having certain hardware-assisted instruction-level debugging capabilities, in accordance with certain example implementations of the present description;

FIG. 6 is block diagram illustrating aspects of an electronic device, for example, as in FIG. 1, having a memory configured as a circular buffer that may be configured for rollover or non-rollover ordering of information as part of a hardware-assisted instruction-level debugging capability, in accordance with certain example implementations of the present description;

FIG. 7 is a flow-diagram illustrating certain actions that may be performed, at least in part, using an electronic device, for example, as in FIG. 1, having a hardware-assisted instruction-level debugging capability and possibly with an external device, in accordance with certain example implementations of the present description; and

FIG. 8 is a flow-diagram illustrating certain further actions that may be performed, at least in part, using an electronic device, for example, as in FIG. 1, having a hardware-assisted instruction-level debugging capability, in accordance with certain example implementations of the present description.

### DETAILED DESCRIPTION

Techniques are presented herein for troubleshooting and debugging of complex circuits, devices, and systems. These techniques include hardware-assisted instruction-level debugging of state sequencers.

Modern systems frequently employ Dynamic Voltage and Frequency Scaling (DVFS) or “work and relax” policies where instruction execution frequency varies based on system activity or for other reasons. In such environments, a single instruction may take a different number of clock cycles to execute depending on the instantaneous frequency. This variability makes benchmarking and root-cause debugging analysis difficult without precise knowledge of the clock speed (Power/Frequency or “PF” state) at the exact moment of execution.

Aspects of the present disclosure provide a hardware-accelerated method and system to capture and correlate instruction-level execution timing with power/frequency (PF) states. This capability may be essential for ensuring the reliability and performance of embedded systems with stringent power and latency requirements.

In an example implementation, an apparatus may be provided for non-intrusive debugging and related benchmarking of electronic devices or some sub-system therein. The example apparatus may include a selection circuit capable of selecting one of a plurality of state sequencers and providing information from a selected sequencer to a debug circuit which may capture and store such information along with contemporaneous device or system information for more precise debugging. Such an apparatus may therefore be configured to support debugging processes across multiple power domains or sequencers within a sub-system or the like.

As described herein in greater detail, the instruction history that is captured may, for example, be stored in a circular buffer utilizing a Last-In, First-Out (LIFO) data retrieval scheme. For each executed instruction, such an example apparatus may store informative metadata, including the Program Counter (PC) or Instruction Memory (IMEM) location, the cycle-accurate execution time, and the corresponding PF state. The inclusion of the PF state may, for example, allow for accurate benchmarking in systems utilizing DVFS or the like by correlating execution time with the applicable operating frequency. Additionally, such an apparatus may be configured to capture a global time stamp synchronized to a reference clock, allowing engineers to correlate state sequencer activity with events occurring in other sub-systems across the SoC or the like. An example debug circuit may be configured to capture a particular number of recent instructions or, possibly employ interrupt signaling, to capture a more complete instruction history of a transition flow.

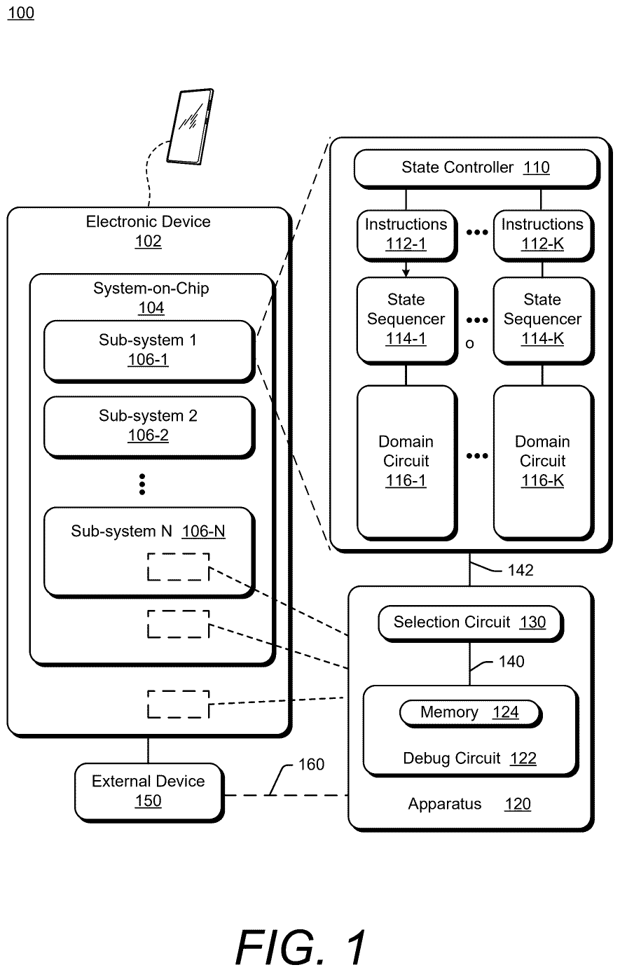

Attention is drawn to FIG. 1, which is a block diagram of an example environment 100 that includes an electronic device 102 having hardware-assisted instruction-level debugging capabilities, in accordance with certain example implementations of the present description. The electronic device 102 is illustrated as including a System-on-Chip (SoC) 104 with a plurality of sub-systems 106 (e.g., a sub-system 1 106-1, a sub-system 2 106-2, . . . , a sub-system N 106-N, where N is a positive integer). However, it should be understood that the SoC 104 may only include a single sub-system 106 in certain instances. The sub-systems 106 may include various circuits and components configured, as may be applicable, to achieve an intended purpose of the given sub-system. In some example implementations, one or more sub-systems 106 may be differently configured, for example, to perform specific processing or to provide certain unique capabilities within the electronic device 102 or the SoC 104. In certain example implementations, two or more sub-systems 106 may be the similarly configured. By way of some non-limiting examples, one or more of the subsystems 106 may comprise all or part of a graphics processing unit (GPU), a central processing unit (CPU), a tensor processing unit (TPU), an artificial intelligence (AI) engine, a media engine, a modem processor, an Application-Specific Integrated Circuit (ASIC), or the like. Although not shown in FIG. 1, it should also be understood that within the sub-systems 106, the SoC 104, or otherwise within the electronic device 102, various other circuits and components may provide an operational infrastructure which may include, for example, communication interfaces, power management functions, clock management functions, and the like to enable the operation and interoperability thereof.

As shown in FIG. 1, as a representative example the sub-system 1 106-1 may include a state controller 110 that is configured to provide instructions 112 for execution by a state sequencer 114 associated with a domain circuit 116. The state sequencer 114 may execute the instructions112 to transition all or part of the domain circuit 116 from one state to another state. By way of example, the domain circuit 116 may be configured to operate in different power consumption states, for example, corresponding to active (operational) state(s) and inactive (idle) state(s), or possibly different voltage or current level states. In another example, the domain circuit 116 may be configured to operate in different frequency or clock states, for example, to increase or decrease processing capabilities, which may also affect power consumption. In certain example implementations, the instructions 112 from the state controller 110 may represent one or more dynamic state transitions, for example, to support certain planned or expected operations regarding all or part of the domain circuit 116. For example, one or more dynamic state transitions may be indicated, at least in part, by way of a software or firmware program, script or possibly a temporal schedule. In some example implementations, the instructions 112 from the state controller 110 may represent one or more adaptive state transitions, for example, to support certain real-time operations or needs regarding all or part of the domain circuit 116. For example, one or more adaptive state transitions may be contemporaneously identified by an AI engine, a sensor, or the like. Both dynamic and adaptive state transitions may address power states, frequency states, or both power and frequency states.

As further illustrated in FIG. 1, the state controller 110 may be configured to provide specific instructions 112-1 through 112-K, where K is a positive integer, to a respective plurality of state sequencers 114-1 through 114-K configured to control state transitions in domain circuits 116-1 through 116-K. Here, instructions 112-1 and 112-K may be the same or different depending on the corresponding state sequencers 114-1 and 114-K or the corresponding domain circuits 116-1 and 116-K.

FIG. 1 also illustrates an example apparatus 120 in accordance with certain example implementations of a hardware-assisted instruction-level debugging capability. As illustrated by the example dashed-lined (alternative) configurations shown in FIG. 1, apparatus 120 may be provided within one or more of the electronic device 102, the SoC 104, the sub-system 106 (e.g., represented by the sub-system 106-N), or some combination thereof. The apparatus 120 in this example includes a debug circuit 122 having a memory 124 and which is coupled to a selection circuit 130. Apparatus 120 is coupled to the sub-system 106-1 in the example. Although not specifically illustrated in this example, as presented in greater detail in this description, the selection circuit 130 may be configured to couple a selected individual one of the plurality of state sequencers 114-1 through 114-K to the debug circuit 122 for capturing certain information associated with the selected state sequencer 114 and the corresponding instructions 112 provided thereto by the state controller 110. In the apparatus 120, for example, the selection circuit 130 and the debug circuit 122 may be operatively coupled through a debug source interface 140, and through which the debug circuit 122 may identify a selected state sequencer 114 and subsequently capture debug information therefrom. The debug information that is captured by the debug circuit 122 may be stored in the memory 124 directly or processed in some manner prior to generate applicable debug information that may be stored, at least in part, in the memory 124.

As further illustrated in FIG. 1, the apparatus 120 may be coupled with the sub-system 106-1 through an interface 142, which may be configured to support bidirectional signaling to support not only the capturing of debug information from the selected state sequencer 114, but also to support possible related feedback signals to the selected state sequencer 114 (or other circuitry) of the sub-system 106-1. For example, in certain implementations the debug circuit 122 may be configured to provide an interrupt signal or the like to the selected state sequencer 114 to temporarily halt or possibly end the execution of the instructions 112 as part of an ongoing debugging process. The debug circuit 122 may remove or counteract such an interrupt signal to inform the selected state sequencer 114 to continue the execution of the instructions 112 as part of an ongoing debugging process.

FIG. 1 also illustrates that an external device 150 may be coupled to the electronic device 102. In accordance with certain example implementations, the external device 150 may be configured to interact in some manner with the electronic device 102 to support a hardware-assisted instruction-level debugging capability provided therein. Thus, by way of an example, the external device 150 and the apparatus 120 may be configured by a connection 160 representing one or more paths within the electronic device 102. In certain instances, the external device 150 may comprise a computing platform or other like device arranged to support hardware-assisted instruction-level debugging capability of one or more of the state sequencers 114, for example, when the electronic device 102 represents a device under test (DUT). In certain example implementation, the external device 150 may request, e.g., via the (representative) connection 160, that debug information for a particular one of the state sequencers 114 be captured by the debug circuit 122 and the selection circuit 130. Such debug information may be stored in memory 124 and provided to the external device 150, for example, via the (representative) connection 160. The external device 150 may further process all or part of the debug information obtained from the apparatus 120 to support applicable hardware-assisted instruction-level debugging.

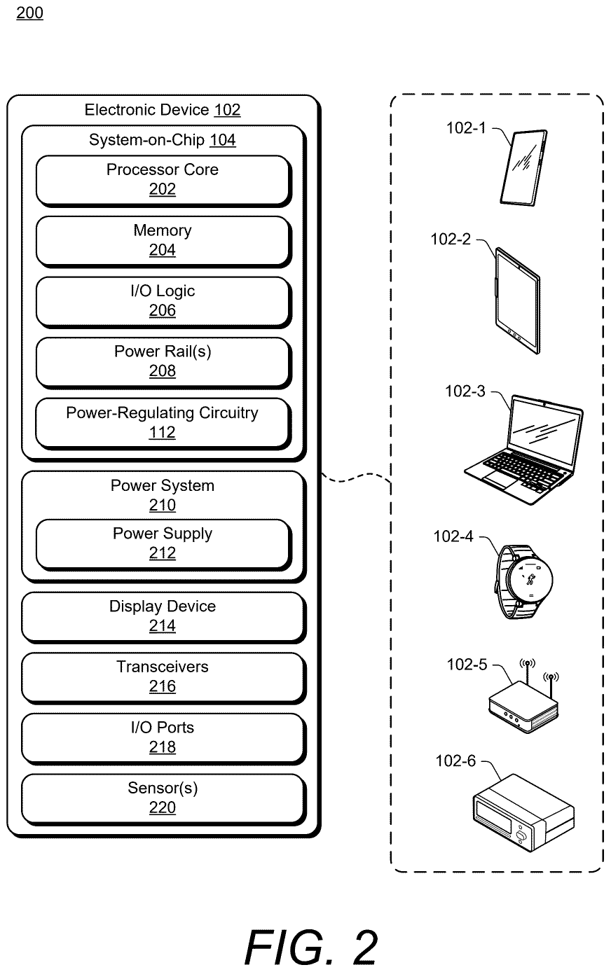

Attention is drawn next to FIG. 2, which illustrates an example implementation 200 of the electronic device 102 from FIG. 1 in more detail. The electronic device 102 may include additional components and interfaces omitted from FIG. 1 for the sake of clarity. The electronic device 102 can be a variety of consumer electronic devices (e.g., computer systems). As non-limiting examples, the electronic device 102 can be a mobile phone 102-1, a tablet device 102-2, a laptop computer 102-3, a wearable computing device 102-4, (e.g., smart-watch), a broadband router 102-5 (e.g., mobile hotspot), or an automotive computing system 102-6 (e.g., navigation and entertainment system). Although not shown, the electronic device 102 may also be implemented as a mobile station (e.g., fixed- or mobile-STA), a mobile communication device, a client device, a user equipment, an entertainment device, a gaming device, a mobile gaming console, a personal media device, a media playback device, a health monitoring device, a drone, a camera, a wearable smart-device, an Internet home appliance capable of wireless Internet access and browsing, an IoT device, and/or other types of user devices. The electronic device 102 may provide other functions or include components or interfaces omitted from FIG. 2 for the sake of clarity or visual brevity.

As shown in FIG. 2, the example SoC 104 includes a processor core 202 and memory 204, which may include computer-readable media, memory media, and/or storage media. The processor core 202 may be implemented as a general-purpose processor core (e.g., of a multicore central-processing unit (CPU) or application processor (AP)), an application-specific integrated circuit (ASIC), graphics processing unit (GPU), or a processor core with other components of the electronic device 102 integrated therewith. The memory 204 can include any suitable type of computer-readable media, memory media, and/or storage media. For example, the memory 204 may include read-only memory (ROM), programmable ROM (PROM), random access memory (RAM), dynamic RAM (DRAM), static RAM (SRAM), or Flash memory. In the context of this disclosure, the memory 204 of the electronic device 102 is implemented as a hardware-based or physical storage device, which does not include transitory signals or carrier waves. Applications, firmware, and/or an operating system (not shown) of the electronic device 102 can be embodied on the memory 204 as processor-executable instructions, which the processor core 202 may execute to provide various functionalities of the electronic device 102. The memory 204 may also store device data, such as user data or user media that is accessible by the applications, firmware, or operating system of the electronic device 102.

In this example, the SoC 104 also includes instances of input/output logic 206 (input/output (I/O) logic 206), one or more power rails 208, and power-regulating circuitry 112. The I/O logic 206 may include circuitry configured to interface control logic of the processor core 202 with various analog and/or digital I/O circuits of the electronic device 102. For example, the I/O logic 206 can enable the processor core 202 or other control logic to interface with sensors, data ports, transceivers, or other components of the electronic device 102. In various implementations, respective circuitry of the processor core 202, memory 204, and I/O logic 206 may operate at different voltages provided by a power system 210 of the electronic device 102 that includes a power supply 212. In some aspects, the power rail 208 of the SoC 104 is coupled to and receives power from the power supply 212. By way of example, all or part of the example circuitry illustrated in the electronic device 102 of FIG. 1 or FIG. 2 may include the sub-system 106-1 (FIG. 1) and in particular at least one of the domain circuits 116 that is responsive to one of the state sequencers 114 and which may support certain examples of the hardware-assisted instruction-level debugging capabilities presented herein.

In aspects, the power system 210 includes one or more power supplies 212, which provide regulated power to the components of the electronic device 102 and/or the SoC 104. In various implementations, an electronic device 102 may include or be configured with a display device 214, transceivers 216, I/O ports 218, and/or sensors 220, which can receive power from the power supply 212 of the power system 210. The power supply 212 of the power system 210 may include any suitable type of power supply, such as linear regulators, switch-mode power supplies (SMPS), multiphase switching regulators, or the like. The power system 210 may receive input power from an external power source (e.g., external AC/DC adapter) or one or more battery cells of a battery or battery pack electrically coupled to the electronic device 102.

The display device 214, transceivers 216, I/O ports 218 and/or sensors 220 of the electronic device 102 may be configured in any suitable fashion and can be operably coupled with the I/O logic 206. For example, the display device 214 may be coupled with the processor core 202 or another processor of the SoC 104 (e.g., graphics processing unit (GPU), not shown) and configured to graphically present an operating system or applications of the electronic device 102. The transceivers 216 enable the electronic device 102 to communicate data (e.g., device data) over wired or wireless networks according to any suitable communication protocol. The I/O ports 218 of the electronic device 102 may include universal serial bus (USB) ports, coaxial cable ports, and other serial or parallel connectors (including internal connectors) useful to couple the user device to various components, peripherals, or accessories (e.g., keyboards, microphones, cameras). Alternatively or additionally, the sensors 220 can enable the electronic device 102 to sense various properties, variances, stimuli, or characteristics of an environment in which the electronic device 102 operates. For example, the sensors 220 may include a motion sensor, an ambient light sensor, an acoustic sensor, a capacitive sensor, an infrared sensor, a temperature sensor, a radar sensor, or a magnetometer.

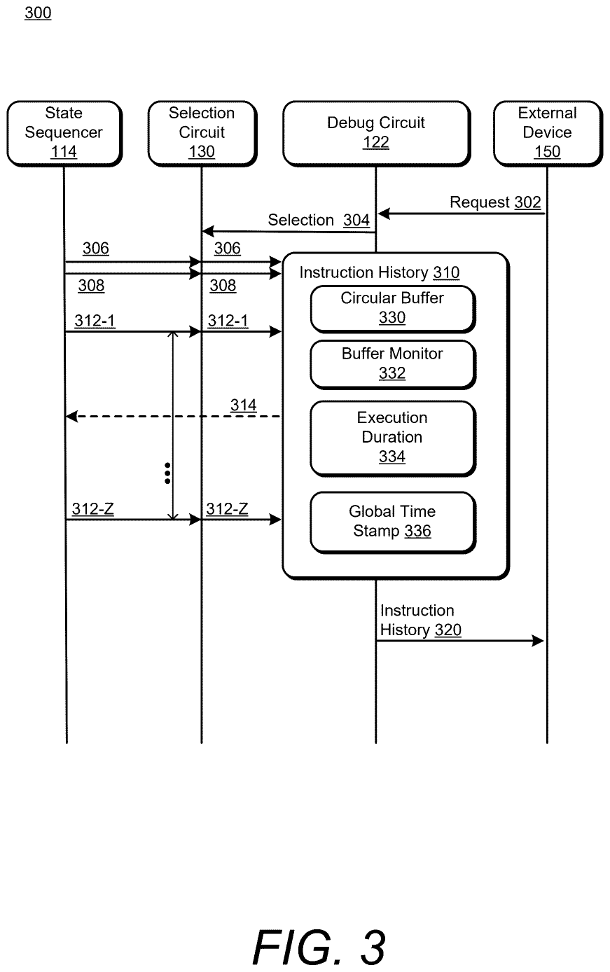

Attention is now drawn to FIG. 3, which is a timing diagram 300 illustrating certain relationships between the electronic device 102, for example, as in FIG. 1, having hardware-assisted instruction-level debugging components provided by the apparatus 120 and with the external device 150, in accordance with certain example implementations of the present description.

More specifically, the example timing diagram 300 illustrates certain actions that may be performed by the state sequencer 114, the selection circuit 130, the debug circuit 122, and the external circuit 150. Here, for example, the passage of time is illustrated beginning at the top of FIG. 3 and increasing as shown by the example actions towards the bottom of FIG. 3. Thus, the example timing diagram 300 illustrates that the external device 150 may send a request 302 to the debug circuit 122. The request 302 may, for example, indicate that debug information is to be captured by the apparatus 120 for a particular (selected) state sequencer 114. The debug circuit 122, in response to the request 302 may provide a selection 304 to the selection circuit 130, for example, identifying the particular state sequencer 114 to be selected. In response to the selection 304, the selection circuit 130 may provide a connection between the selected state sequencer 114 and the debug circuit 122. By way of an example, the selection circuit 130 may include a multiplexor configured to provide an applicable connection between the debug circuit 122 and multiple state sequencers, one of which is the (currently selected) state sequencer 114. In other example implementations, the selection circuit 130 may comprise crossbar switches, routing logic, shared bus arbitration logic, or any switching fabric capable of selectively routing signals from one of the state sequencers to the debug circuit 122.

With the connection established between the debug circuit 122 and the state sequencer 114 through the selection circuit 130, various signals may be captured by the debug circuit 122. For example, a signal 306 may be captured by the debug circuit 122 which is indicative of a current instruction location of the state sequencer 114. A signal 308 may be captured by the debug circuit 122, which is indicative of a state transition trigger of the state sequencer 114. For example, the signal 306 may provide an initial instruction location within instruction history 310 and the “trigger” relayed in signal 308 may initiate additional (subsequent) capturing of signals for the instruction history 310. For example, signals 312-1 through 312-Z (e.g., where Z is a positive integer) may be captured by the debug circuit 122.

The instruction history 310 illustrated by example in FIG. 3 includes a circular buffer 330 which may be proved in the memory 124 (FIG. 1), a corresponding buffer monitor 332, an execution duration 334, and a global time stamp 336 to illustrate certain aspects of the debug circuit 122. The buffer monitor 332 may, for example, be responsive to a buffer or memory related event occurrence that may interrupt or otherwise halt execution of the instructions 112 by the state sequencer 114, as illustrated by a signal 314. The execution duration 334 may, for example, be determined by the debug circuit 122 based on (timing) information that is captured or otherwise obtained and may represent cycle-accurate execution duration for one or more instructions executed by the state sequencer 114. The global time stamp 336 may, for example, be representative of a global clock time associated with the electronic device 102. All or part of the information in or associated with the instruction history 310 may be provided in one or more signals 320 from the debug circuit 122 to the external device 150.

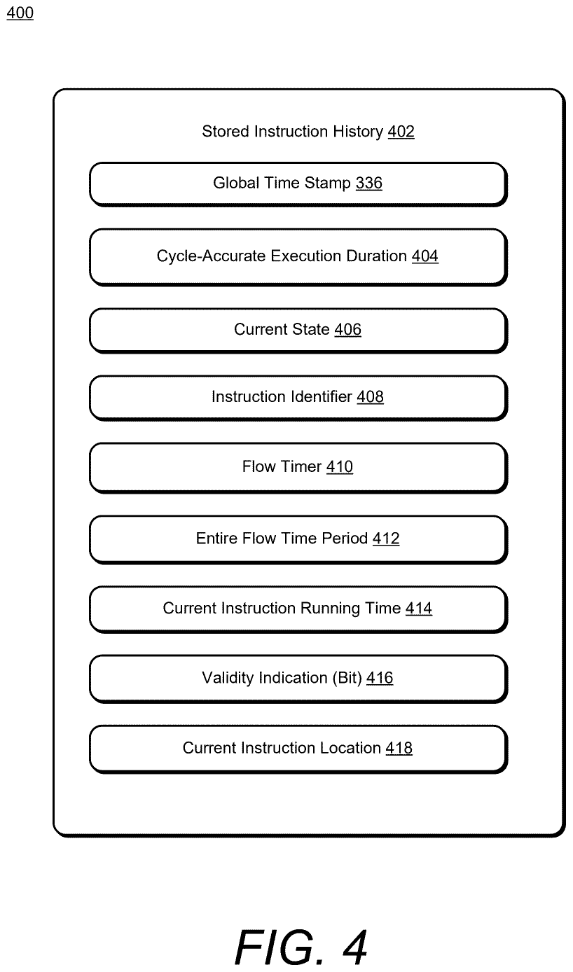

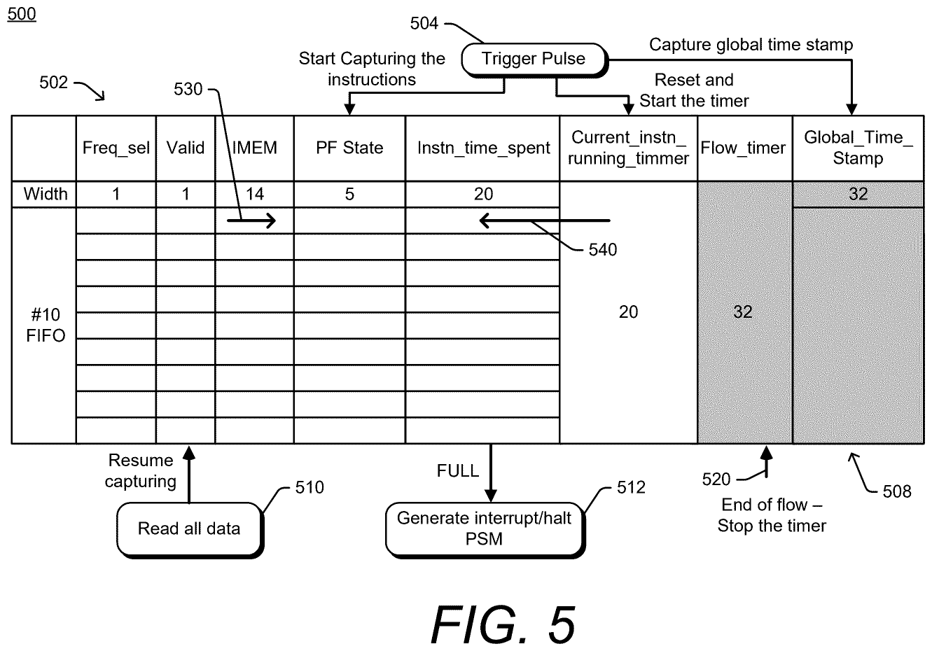

Attention is drawn next to FIG. 4, which is a block diagram 400 illustrating some example types of debugging information that may be part of a stored instruction history 402, for example, in the memory 124 (FIG. 1), in accordance with certain example implementations of the present description. In this example, the stored instruction history 402 may include information for the global time stamp 336, a cycle-accurate execution duration 404, a current state 406, one or more instruction identifiers 408, a flow timer 410, an entire flow time period 412, a current instruction running time 414, one or more validity indications 416, and a current instruction location 418. Each of these non-limiting examples represents types of instruction/debugging information that may be of use in a given debugging process and are therefore described in greater detail in the examples of FIGS. 5-8.

Attention is drawn next to FIG. 5, which is block diagram 500 illustrating aspects of the electronic device 102 (FIG. 1), in accordance with certain example implementations of the present description. The example block diagram 500 includes a representative table 502 having debug information therein. By way of example all or part of the debug information in the representative table 502 may be stored in the memory 124 of the debug circuit 122 (FIG. 1). The example block diagram 500 also includes certain actions that may be performed by the debug circuit 122 as part of a debugging process. For example, at block 504 a trigger pulse may initiate certain actions regarding the capturing or processing of debug information. In other examples, applicable actions may be taken at block 510 to read all data or resume capturing/processing debug information, e.g., based, at least in part, on the validity indication 416 illustrated here as a single logical bit in the representative table 502 in the column labeled “Valid.” In another example, at block 512 an action may be taken by the debug circuit 122 to generate an interrupt signal to halt the execution of the instructions by the selected state sequencer 114 (here, e.g., which may include a PSM), based, at least in part, on instruction time spent information in the representative table 502 in the column labeled “Instn_time_spent” being consider “FULL” within the memory 124 at some point in a debugging process.

The example representative table 502 includes several columns and rows of debug information that may be captured or otherwise obtained or processed by the debug circuit 122. Here, for example, a “Width” labeled row is provided which indicates example bit lengths that may be used for the example columns shown in this table of ten rows, (e.g., here a “#10 circular FIFO). It should be understood that in other example implementations, a buffer provided in the memory 124 need not be so limited regarding the debug information in the example columns and row shown in the table 502. In the example table 502, each of the rows of debug information may be associated with a given instruction location 418 (e.g., IMEM) or like identifier of an instruction flow of interest in a debugging process. Here, for example, the descending rows in the example table 502 may correspond to sequential instructions being executed.

In the example representative table 502, a column labeled as “Freq-sel” may include a logical bit that indicates whether the selected state sequencer 114 is running a high speed or a low speed. Such debug information may be used to accurately calculate a time spent per each instruction executed.

The column labeled as “Valid” may include a logical bit that indicates, e.g., for a given instruction, whether the buffer in the memory 124 corresponding to the table 502 is rolled over. Such debug information may be used to convert the example FIFO buffer to produce a LIFO order or to indicate that a given instruction executed properly.

A column labeled as “IMEM” may include a 14-bit instruction address or like identifier. For example, such debug information may be encoded with opcode and operands for the IMEM, which may be decoded to determine the operation(s) associated with a given instruction. Here, for example, such decoding of an IMEM may be performed at the external device 150.

A column labeled as “PF State” may include a 5-bit current state value, which may identify a voltage/frequency combination of the selected state sequencer 114 at the time when a given instruction is executed. As illustrated, such debug information may be captured in response to a trigger pulse at the block 504. This current state value may be useful for performing benchmarking of different devices or components which may employ DVFS or the like. Since a single instruction may consume a variable number of clock cycles depending on the frequency, capturing the PF State may be used to normalize timing data and possibly to support accurate root-cause analysis.

The column labeled as “Instn_time_spent” may include a 20-bit indication of time, which may include the cycle-accurate execution time 404 as measured or otherwise calculated. Similarly, a column labeled as “Current_instn_running_timmer” may also include a 20-bit indication of time, which may include the current instruction running time 414 as measured or otherwise calculated. The cycle-accurate execution time 404 may, for example, be calculated at least in part by summing the current instruction running time 414 as each instruction is executed.

A column labeled as “Flow_timer” may include a 32-bit indication of time indicating the entire flow time period 412, as measured for example from the trigger pulse at the block 502 which may reset and start an applicable timer function (e.g., a local flow timer that may be used to measure or otherwise determine the total duration of a state transition sequence). The column labeled as “Global_time_stamp” may also include a 32-bit indication of a time captured as the global time stamp 336, for example, in response to the trigger pulse at the block 502 when a flow execution of instructions is initiated. In the example representative table 502, the shading 508 of the columns labeled as “Flow_timer” and “Global_time_stamp” is intended to indicate that the applicable indications of time in these two columns may be based on a reference clock, e.g., of the electronic device 102. Thus, for example, the global time stamp 336 may be captured or otherwise obtained from a “global: reference clock or like counter, which may allow the specific state transition event to be correlated temporally with events occurring in other subsystems across the SoC 104 or elsewhere in the electronic device 102. Although not illustrated in FIG. 5, a current buffer pointer indication may be used to represent a current row (instruction) illustrated in the example table 502. An arrow labeled 520 illustrates an example end of the instruction flow point where the flow timer may be stopped.

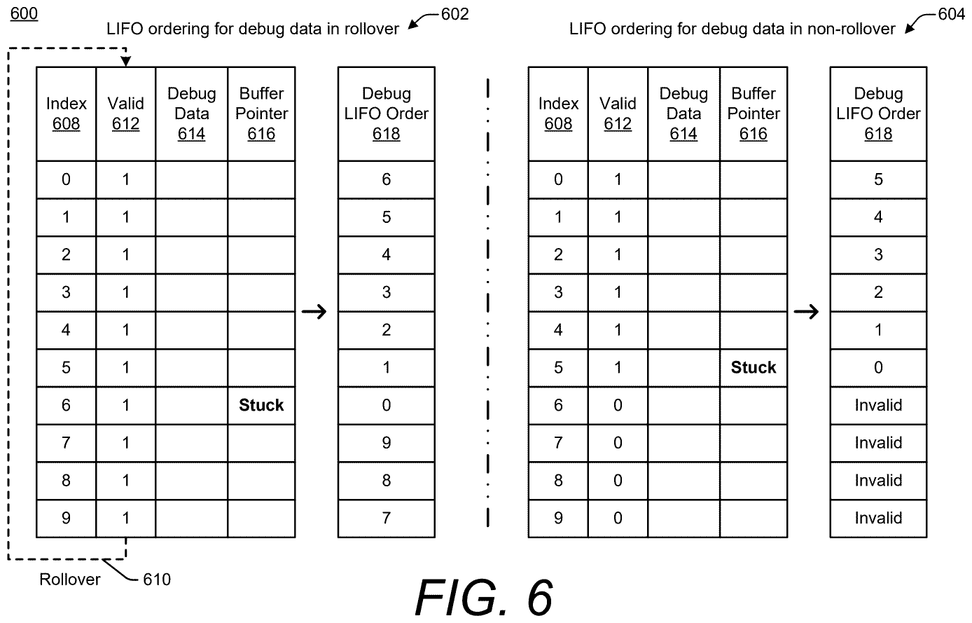

Attention is now drawn to FIG. 6, which is block diagram 600 illustrating aspects of the memory 124 configured as a circular buffer having rollover ordering or non-rollover ordering of debug information, in accordance with certain example implementations of the present description.

A portion of a LIFO ordered buffer 602 illustrates an example (circular) buffer rollover approach. The LIFO ordered buffer 602 may include an index column 608 shown here with an ascending numerical order from 0-9, a validity indication (bit) column 612, a representative debug data 614 (e.g., see the example table 502 in FIG. 5 for examples of debug information), and a corresponding representative buffer pointer column 616. The example LIFO ordered buffer 602 is configured to rollover at action 610. As illustrated, at index 608 value “6”, which is indicated as valid (a “1”) in valid column 612, the instruction flow has become “stuck” (or otherwise failed to properly execute) as marked in the corresponding buffer pointer column 616. In response to the instruction flow being stuck as shown, a debug LIFO order column 618 (0 through 9) may be set (reset) to indicate the instruction that “stuck” is indicated by at “0” in the debug LIFO order column 618 column.

The example LIFO ordered buffer 604, which is similar to the example LIFO ordered buffer 602, is not however configured to rollover. As illustrated, at index 608 value “5”, which is indicated as the last valid entry in the valid column 612, the instruction flow has become “stuck” (or otherwise failed to properly execute) as marked in the corresponding buffer pointer column 616. In response to the instruction flow being stuck as shown, the debug LIFO order column 618 (0 through 9) may be set (reset) such that the instruction that “stuck” is indicated by at “0” in the debug LIFO order column 618 column. However, since the example LIFO ordered buffer 604 is not configured to rollover, the remaining rows marked by the index 710 as “6,” “7,” “8,” and “9” are indicated as being invalid (“0”) in the valid column 712 and similarly in the debug LIFO order column 718. In this manner, a “stuck” instruction may be identified as part of a debugging process.

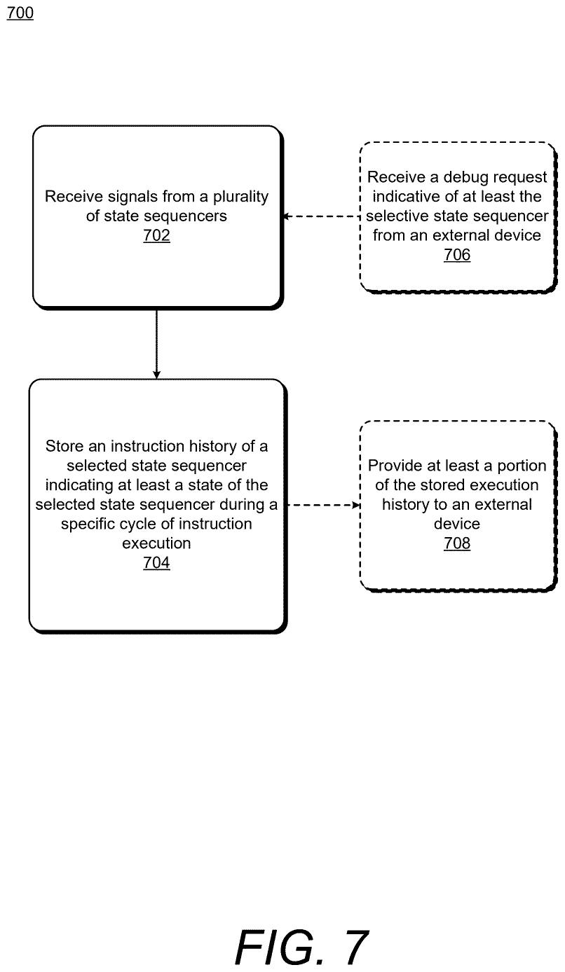

Attention is now drawn to FIG. 7, which is a flow-diagram 700 illustrating certain actions that may be performed, at least in part, using the electronic device 102, for example, as in FIG. 1, having the apparatus 120 and a plurality of the (selectable) state sequencers 114.

At example block 702, one or more signals may be received from at least one of the plurality of state sequencers. And a given one of the state sequencers 114 may be selected by the selection circuit 130 (FIG. 1). For example, the selection circuit 130 may be responsive to one or more signals from the debug circuit 122 indicating such a selection preference.

At example block 704, an instruction history may be stored in the memory 124. The instruction history may be indicated, at least in part, by one or more of the signals received from the selected state sequencer 114. The instruction history may, for example, indicate at least a state of the selected state sequencer 114 during a specific cycle or flow of instruction execution.

In certain example implementations, an action at example block 706 may correspond to the example action 702. In the example block 706, a debug request may be received, for example, by debug circuit 122 from the external device 150 (FIG. 1) which is indicative of the state sequencer 114 of interest in a debugging process.

In certain example implementations, an action at example block 708 may correspond to example action 704. In the example block 708, at least a portion of the stored instruction history in the memory 124 of the debug circuit 122 may be provided to the external device 150.

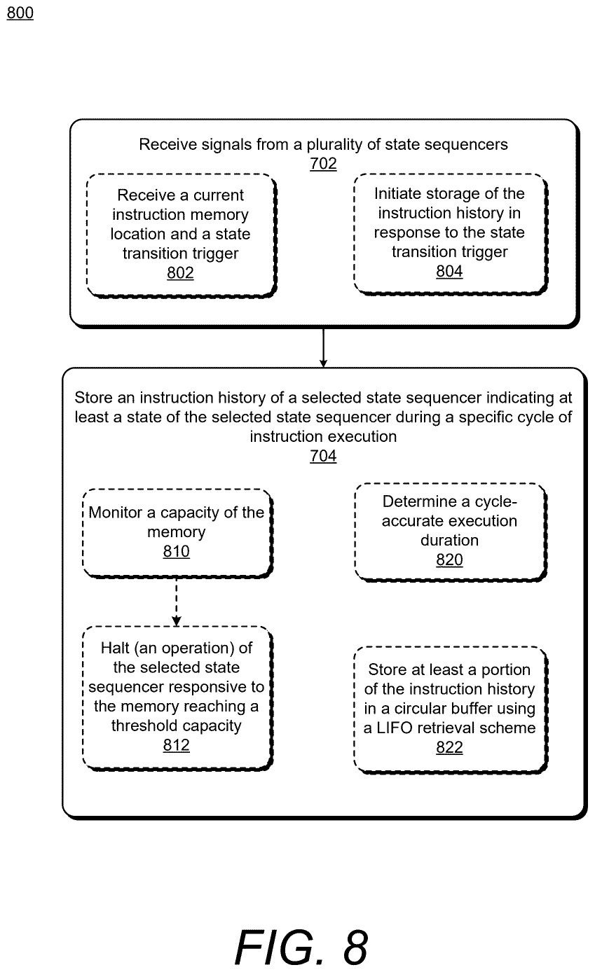

Attention is now drawn to FIG. 8, which is a flow-diagram 800 illustrating certain further actions that may be performed, at least in part, using the apparatus 120 (FIG. 1) to provide a hardware-assisted instruction-level debugging capability, in accordance with certain example implementations of the present description. In the example flow diagram 800, the example blocks 702 and 704 of FIG. 7 are illustrated as possibly including or otherwise being supported by additional (optional) actions.

At example block 802, at least a portion of the signals received at example block 702 from the selected state sequencer 114 may be indicative, at least in part, of the current instruction memory location 418 (e.g., an IMEM) and the state transition trigger 504. At example block 804, in response to the state transition trigger 504 in the example block 802 the storing of the instruction history (e.g., at example block 704) may be initiated.

At example block 810, the storage actions in example block 704 may include monitoring a capacity of the memory 124 configured to store the instruction history. For example, the memory 124 may be configured to store the instruction information in a circular buffer. At example block 812, the selected state sequencer 114 may be halted in some manner to temporarily stop or possibly to end further instruction execution in responsive to the memory capacity monitored in the example block 810 reaching a threshold capacity. For example, the example block 812 may include the debug circuit 122 providing one or more signals 314 (FIG. 3) to the state sequencer 114.

At example block 820, the debug circuit 122 may be configured to determine, e.g., for each specific cycle of instruction execution, the cycle-accurate execution duration 404 (FIG. 4). For example, the cycle-accurate execution duration 404 may be determined, at least in part, by using the timing instruction information shown in example table 502, e.g., the global time stamp 336, the flow timer 410, or other like time information. In certain instances, the debug circuit 122 may store, for each instruction in the stored instruction history, at least the cycle-accurate execution duration 404 and the current state 406 as being associated with the instruction identifier 408.

In certain instances, the instruction history stored at the example block 704 may include, e.g., for each instruction, the global time stamp 336, the flow timer 420 (e.g., corresponding to an entire instruction flow time period at the particular instruction execution time), the current instruction running time 414, a validity indicator 416, or some combination thereof or the like. At example block 822, at least a portion of the instruction history may be stored in the memory 124 as a circular buffer configured to store a predetermined number of instructions of the instruction history, e.g., using a LIFO or other like retrieval scheme.

The hardware-assisted instruction-level debugging techniques presented herein addresses a critical gap in modern SoC design. By providing visibility into the “black box” of power sequencers, these techniques may enable more precise diagnosis of a hang (a stuck) and performance bottlenecks. The unique combination of LIFO buffering, PF state capture, and global timestamping ensures that engineers can accurately benchmark and debug systems operating under dynamic voltage and frequency scaling or the like, ensuring the reliability of complex embedded systems.

Although aspects of hardware-assisted instruction-level debugging have been described in language specific to features and/or methods, the subject of the appended claims is not necessarily limited to the specific features or methods described. Rather, the specific features and methods are disclosed as example implementations of the techniques, and other equivalent features and methods are intended to be within the scope of the appended claims. Further, various aspects are described, and it is appreciated that each described aspect can be implemented independently or in connection with one or more other described aspects.

What is claimed is:

1. A method for use in an apparatus having a plurality of state sequencers, the method comprising:
receiving signals from the plurality of state sequencers; and
storing an instruction history indicated, at least in part, by one or more of the signals received from a selected one of the state sequencers, the instruction history indicating at least a state of the selected state sequencer during a specific cycle of instruction execution.

2. The method of claim 1, further comprising:
determining, for each specific cycle of instruction execution, a cycle-accurate execution duration; and
storing, for each instruction in the stored instruction history, at least the cycle-accurate execution duration and the state as being associated with an identifier of the instruction.

3. The method of claim 1, and wherein the storing the instruction history further comprises, for each instruction in the stored instruction history, storing:
a global time stamp;
a flow timer corresponding to an entire instruction flow time period;
a current instruction running time;
a validity bit indicating whether the respective instruction has been completely executed;
or some combination thereof.

4. The method of claim 1, wherein the signals from the selected state sequencer are indicative, at least in part, of a current instruction memory location and a state transition trigger, and wherein the storing the instruction history is initiated in response to the state transition trigger.

5. The method of claim 4, wherein the state transition trigger is associated with a power state transition, a frequency state transition, a dynamic state transition, an adaptive state transition, or some combination thereof.

6. The method of claim 1, wherein the storing the instruction history comprises storing at least a portion of the instruction history in a circular buffer configured to store a predetermined number of instructions of the instruction history using a Last-In, First-Out (LIFO) retrieval scheme.

7. The method of claim 1, wherein the storing the instruction history comprises storing at least a portion of the instruction history in a memory, and further comprising:
monitoring a capacity of the memory;
halting the selected state sequencer responsive to the memory reaching a threshold capacity.

8. The method of claim 1, further comprising:
receiving a debug request indicative of at least the selective state sequencer from an external device; and
providing at least a portion of the stored execution history to the external device.

9. An apparatus comprising:
a selection circuit configured to receive signals from a plurality of state sequencers and route the signals from a selected state sequencer to a debug source interface; and
a debug circuit coupled to the debug source interface, the debug circuit comprising a memory configured to store an instruction history of the selected state sequencer, the debug circuit being configured to record in the memory, for each instruction in the instruction history, at least a state of the selected state sequencer during a specific cycle of instruction execution.

10. The apparatus of claim 9, wherein the debug circuit is further configured to:
determine, for each specific cycle of instruction execution, a cycle-accurate execution duration; and
store, for each instruction in the stored instruction history, at least the cycle-accurate execution duration and the state as being associated with an identifier of the instruction.

11. The apparatus of claim 9, wherein the signals from the selected state sequencer are indicative of at least a current instruction memory location and a state transition trigger from the selected state sequencer, and wherein the debug circuit is configured to initiate recording of the instruction history in the memory in response to the state transition trigger.

12. The apparatus of claim 11, wherein the state transition trigger is associated with a power state transition, a frequency state transition, a dynamic state transition, an adaptive state transition, or some combination thereof.

13. The apparatus of claim 9, wherein the memory includes a circular buffer configured to store a predetermined number of instructions of the instruction history, and wherein the debug circuit is configured to manage the circular buffer using a Last-In, First-Out (LIFO) retrieval scheme.

14. The apparatus of claim 9, wherein the debug circuit is configured to record a validity bit for each instruction in the instruction history, the validity bit indicating whether the respective instruction has been completely executed.

15. The apparatus of claim 9, wherein the debug circuit is configured to monitor a capacity of the memory and provide an interrupt to halt the selected state sequencer responsive to the memory reaching a threshold capacity.

16. The apparatus of claim 9, wherein the selection circuit is configured to route the signals from the selected state sequencer to the source interface responsive to a selection input from the debug circuit.

17. The apparatus of claim 16, wherein the debug circuit is configured to:
generate the selection input to the selection circuit in response to a debug request from an external device indicative of at least the selective state sequencer, and
output at least a portion of the execution history stored in the memory to the external device.

18. The apparatus of claim 9, wherein, for each instruction in the instruction history, the debug circuit is configured to record in the memory:
a global time stamp;
a flow timer corresponding to an entire instruction flow time period;
a current instruction running time;
or some combination thereof.

19. The apparatus of claim 9, wherein the selected state sequencer includes a power/frequency state machine (PFSM) or a power state machine (PSM).

20. The apparatus of claim 9, and further comprising at least one subsystem circuit including:
a state controller;
a plurality of domain circuits; and
the plurality of state sequencers coupled to the state controller, each state sequencer being coupled to a respective domain circuit of the plurality of domain circuits, each state sequencer being configured to execute instructions from the state controller to control the state of the respective domain circuit, and each of the plurality of state sequencers being coupled to the selection circuit and configured to provide respective signals to the selection circuit.
